(19) United States
(12) Patent Application Publication
(10) Pub. No.: US 2015/0272196 A1
(43) Pub. Date: Oct. 1, 2015

(54) ATHLETIC PERFORMANCE ENHANCING BEVERAGE

(71) Applicant: CAMPBELL SOUP COMPANY, Camden, NJ (US)

(72) Inventors: Joshua Christian Anthony, Princeton Junction, NJ (US); Kyle David Kent, Medford, NJ (US); Barbara Louise Winters, Moorestown, NJ (US); Hye Won Yeom, Mount Laurel, NJ (US)

(21) Appl. No.: 14/668,538

(22) Filed: Mar. 25, 2015

Related U.S. Application Data
(60) Provisional application No. 61/969,936, filed on Mar. 25, 2014.

(51) Int. Cl. A23L 2/02

(52) U.S. Cl. CPC A23L 2/02; A23V 2002/00

(57) ABSTRACT

Embodiments of the invention include an athletic performance enhancing beverage. In an embodiment, the invention includes a beverage including a fruit or vegetable juice, wherein the fruit or vegetable juice provides at least 50% of the carbohydrates of the beverage; and water; wherein the ratio of glucose+sucrose:fructose in the beverage exceeds a ratio of 2:1. Other embodiments are also included herein.

This application claims the benefit of U.S. Provisional Application No. 61/969,936, filed Mar. 25, 2014, the content of which is herein incorporated by reference in its entirety.

### FIELD OF THE INVENTION

The present invention relates to an athletic performance enhancing beverage and related methods.

### BACKGROUND OF THE INVENTION

During exercise, many physiological processes can take place that may function to reduce athletic performance including lactate production, fluid loss, electrolyte loss, resulting perceived exhaustion, and the like.

Various beverages have been formulated to support the continued exertion of athletes. However, many beverages have proven to provide little benefit while undesirably providing a relatively large number of calories.

### SUMMARY OF THE INVENTION

Embodiments of the invention include an athletic performance enhancing beverage and related methods. In an embodiment, the invention includes a beverage including a fruit or vegetable juice, wherein the fruit or vegetable juice provides at least 50% of the carbohydrates of the beverage; and water; wherein the ratio of glucose+sucrose:fructose in the beverage exceeds a ratio of 2:1. Other embodiments are also included herein.

In an embodiment, the invention includes a beverage concentrate or dry mix. The beverage concentrate or dry mix can include a fruit or vegetable juice concentrate or powder, wherein the fruit or vegetable juice concentrate or powder provides at least 50% of the carbohydrates of the beverage. The beverage can have a ratio of glucose+sucrose:fructose exceeding a ratio of 2:1.

In an embodiment, the invention includes a method of making a beverage. The method can include mixing a fruit or vegetable juice, wherein the fruit or vegetable juice provides at least 50% of the carbohydrates of the beverage with water and an acidulant, wherein the ratio of glucose+sucrose:fructose in the beverage exceeds a ratio of 2:1.

In an embodiment, the invention includes a method of enhancing athletic endurance. The method can include administering a beverage to a subject, the beverage comprising a fruit or vegetable juice, wherein the fruit or vegetable juice provides at least 50% of the carbohydrates of the beverage and water, wherein the ratio of glucose+sucrose:fructose in the beverage exceeds a ratio of 2:1.

In some embodiments, the invention includes a food product including a fruit or vegetable juice product. The fruit or vegetable juice product provides at least 50% of the carbohydrates of the food product and the ratio of glucose+sucrose:fructose in the food product exceeds a ratio of 2:1.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description. The scope of the present invention is defined by the appended claims and their legal equivalents.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments of beverages, concentrates, powders, and food products herein can be used to support hydration, exercise preparation, exercise performance, and exercise recovery. In some embodiments, the beverage, concentrate, powder, or food product can support exercise recovery and augment subsequent exercise performance. In some embodiments, the beverage, concentrate, powder, or food product can support hydration and help maintain body temperature during exercise. These studies demonstrate that juices derived from vegetables and/or fruits can be used to support hydration, exercise performance, and exercise recovery.

### Bulk Properties

In various embodiments, the beverage can include a relatively high amount of glucose (or D-glucose)+sucrose to fructose. In some embodiments, exemplary fruit or vegetable juice compositions used in embodiments herein can include an amount of glucose+sucrose to fructose in a ratio of at least 1:1, at least 1.5:1, at least 2:1, at least 3:1, at least 4:1, at least 5:1, at least 6:1, at least 7:1, at least 8:1, or higher.

In various embodiments, the amount of calories in the beverage can be relatively low for a hydrating beverage. In some embodiment, the amount of calories in the beverage can be less than about 120 calories per 12 ounce serving. In other embodiments the amount of calories in the beverage can be less than about 110, 100, 90, 80, 70, 60, 50, or 40 calories per 12 ounce serving. In some embodiments, the beverage can formulated to include less than 30 calories per 12 ounce serving, less than 25 calories per 12 ounce serving, less than 20 calories per 12 ounce serving, less than 15 calories per 12 ounce serving, or less than 10 calories per 12 ounce serving. In some embodiments, the beverage can formulated to include more than 0 calories per 12 ounce serving, more than 1 calorie per 12 ounce serving, more than 5 calories per 12 ounce serving, more than 10 calories per 12 ounce serving, or more than 15 calories per 12 ounce serving.

Embodiments herein can also include particular ratios of electrolytes. In some embodiments, beverages in accordance with embodiments herein can include a ratio of sodium to potassium of from about 1:0.5 to about 1:8. In some embodiments the ratio of sodium to potassium can be from about 1:1 to about 1:5, 1:1.5 to about 1:4, 1:1.5 to about 1:3, or 1:1.75 to 1:2.25. In some embodiments, the ratio of sodium to potassium can be about 1:2.

The absolute amounts of ions such as sodium, potassium, calcium, and magnesium can vary based on a number of factors. However, in some embodiments, the amount of sodium can be from about 15 mg to about 150 mg in an 8 ounce serving of the beverage herein. In some embodiments, the amount of sodium can be from about 25 mg to 75 mg. In some embodiments, the amount of sodium can be from about 40 to about 60 mg. In some embodiments, the amount of potassium can from about 15 mg to about 150 mg in an 8 ounce serving of the beverage herein. In some embodiments, the amount of potassium can be from about 75 mg to about 125 mg. In some embodiments, the amount of potassium can be from about 90 mg to about 110 mg. The beverage can also include from about 0 to about 10 mg of calcium. The beverage can also include from about 0 to about 20 mg of magnesium.

In some embodiments, the beverage can be substantially isotonic. In some embodiments, the beverage can be hypotonic. In some embodiments, the beverage can be from about 200 mOsm to about 400 mOsm. In some embodiments, the beverage can be from about 250 mOsm to about 350 mOsm. In some embodiments, the beverage can be from about 275 mOsm to about 325 mOsm. In some embodiments, the beverage can be less than about 340, 300, 260, 220, 180, 140, 100, or 60 mOsm.

### Vegetable and Fruit Juices

In various embodiments, the beverage (or beverage mix powder, concentrate, or food product) includes one or more fruit or vegetable juice compositions. The term “fruit or vegetable juice composition” shall refer to fruit or vegetable juices, fruit or vegetable juice concentrates, or fruit or vegetable juice dehydrated products such as powders. In the case of concentrates or dehydrated products, they will approximate non-concentrated corresponding specie and/or varietal juices compositionally except for the amount of water that is present.

In some embodiments, the amount of juice in the beverage can be substantial. For example, in some embodiments the beverage can include at least about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or about 100% of a fruit and/or vegetable juice(s). It will be appreciated, however, that as per 21 CFR §101.30 a beverage can be considered to contain 100 percent juice and still also contain non-juice ingredients that do not result in a diminution of the juice soluble solids.

Exemplary fruit or vegetable juice compositions used in embodiments herein contain a relatively high amount of glucose (or D-glucose)+sucrose to fructose. In some embodiments, exemplary fruit or vegetable juice compositions used in embodiments herein include an amount of glucose+sucrose to fructose in a ratio of at least 1:1, at least 1.5:1, at least 2:1, at least 3:1, at least 4:1, at least 5:1, or higher.

Exemplary fruit or vegetable juice compositions can include compositions from the juices of root vegetables. In some embodiments, exemplary fruit or vegetable juice compositions can include compositions including one or more of sweet potato, carrot, celery, peach, orange, pineapple, banana, and sour cherry juices. In some embodiments, the beverage can include one or more of sweet potato, carrot, peach, and orange juices. While not intending to be bound by theory, some varieties of sweet potato juice can be particularly well suited for beverage applications described herein because of the naturally high glucose+sucrose to fructose ratio contained therein.

It has been found that juice from some varieties of yellow or white flesh sweet potatoes (versus common orange or purple flesh sweet potatoes) have a particularly favorable sugar profile for beverages in accordance with embodiments herein. In specific, juice from some varieties of yellow or white flesh sweet potatoes can have a relatively high ratio of glucose+sucrose:fructose. In various embodiments, the fruit or vegetable juice comprises the juice of a yellow or white flesh sweet potato. In some embodiments, the fruit or vegetable juice comprises the juice of a yellow or white flesh sweet potato.

Some types of sweet potato juice have exceptional properties in terms the ratio of glucose+sucrose:fructose. In some embodiments, the fruit or vegetable juice comprises the juice of a sweet potato, wherein the juice has a glucose+sucrose:fructose ratio of at least 1:1, 1.5:1, 2:1, 3:1, 4:1, or 5:1.

In various embodiments, the fruit or vegetable juice composition provides at least 50% of the carbohydrates of the beverage. In some embodiments, the fruit or vegetable juice composition provides at least about 60%, 65%, 70%, 75%, 80%, 85%, 90%, 95%, 97%, 98%, 99% or 100% of the carbohydrates of the beverage. In various embodiments, the fruit or vegetable juice composition provides less than 100% of the carbohydrates of the beverage. In some embodiments, the fruit or vegetable juice composition provides a percentage of carbohydrates of the beverage that is in a range wherein any of the previous percentages can serve as either the lower or upper bound of the range.

In various embodiments, the fruit or vegetable juice composition can also include an amount of a fruit or vegetable juice other than those discussed above (despite having a lower ratio of glucose+sucrose to fructose). In some embodiments, the amount of juice from this other type of fruit or vegetable can be small enough so as to not impact the sugar ratio substantially but large enough to achieve a specific purpose such as flavoring, color, or the like.

### Other Naturally-Derived Carbohydrate Containing Inputs

In various embodiments, the beverage (or beverage mix powder, concentrate, or food product) can include one or more naturally-derived carbohydrate inputs in place of (partially or totally) the fruit or vegetable juice compositions. Naturally-derived carbohydrate inputs can include, but are not limited to, tree saps or syrups, molasses, nut milks, and grain milks. In particular, such naturally-derived carbohydrate inputs can include those having a glucose+sucrose:fructose ratio of at least 1:1, 1.5:1, 2:1, 3:1, 4:1, or 5:1.

### Sweetness Enhancers

In various embodiments, one or more sweetness enhancers can be included. Sweetness enhancers can include, but are not limited to, high intensity sweeteners. High intensity sweeteners can include both natural high intensity sweeteners and artificial high intensity sweeteners. Natural high intensity sweeteners can include Rebaudioside A, stevia glycoside, mogrosides, and the like. Artificial high intensity sweeteners can include sucralose.

In some embodiments, the beverage can also include normal intensity sweeteners, including, but not limited to, sugar alcohols (xylitol, erythritol, maltitol, sorbitol, mannitol, lactitol, and the like), mono and disaccharide sweeteners (including sucrose, high fructose corn syrup, fructose, glucose, galactose, maltose, and lactose), and others. In some embodiments, the beverage can also include natural sweeteners and extracts including, but not limited to, honey, maple syrup, agave, brown rice syrup, golden syrup, and the like.

In various embodiments, the amount of sweetener is sufficient to provide a sweet taste despite the presence of other beverage components. Based on the varying sweetness equivalents of different sweeteners, the actual amount used will depend on the particular sweetener used. However, the amounts used can vary from 0.001 wt. % to more than 0.05 wt. %.

### Acidulants

Various food grade acidulants can be used in various embodiments herein. Food grade acidulants can include carboxylic acids. Food grade acidulants can specifically include, but are not limited to, phosphoric acid and phosphates, hydrochloric acid, sulfuric acid, acetic acid and salts thereof, propionic acid and salts thereof, lactic acid and derivatives thereof, succinic acid and succinic anhydride, fumaric acid and its salts, malic acid and malic anhydride, tartaric acid and salts thereof, adipic acid, citric acid and salts thereof, benzoic acid and salts thereof, sorbic acid and salts thereof, caprilyc acid, butyric acid, glucono delta lactone, and amino acids. In various embodiments, acidulants used herein are selected from the group consisting of citric acid, malic acid, malic anhydride, and salts of any of these.

In some embodiments, the pH of the beverage is sufficiently low (acidic) so as to be conducive to shelf-stability and inhibit the growth of microorganisms. In some embodiments, the pH of the beverage is less than about 5.0. In some embodiments, the pH of the beverage is less than about 4.5, 4.0, or 3.5. In some embodiments, the pH of the beverage is not so low as to interfere with the organoleptic properties of the beverage. In some embodiments, the pH of the beverage is greater than about 2.0. In some embodiments, the pH of the beverage is greater than about 2.5, 3.0, 3.5, or 4.0. In some embodiments, the pH is in a range wherein any of the above pH numbers can serve as the upper or lower bound of the range. In a particular embodiment, the pH is greater than or equal to 2.5 and less than or equal to 4.5.

### Water

Beverages in accordance with embodiments herein can include an amount of water in order to get the total percent solids (or brix) of the beverage in a desirable range for the particular application. By way of example, in some embodiments, in a RTD (ready-to-drink) athletic performance enhancing beverage, an amount of water can be added in order to result in a beverage of about 4.0 brix to about 6.2 brix, or about 4.8 to 5.4 brix.

In a different embodiment, such as a spa-water type beverage, the amount of water can be higher so as to result in a beverage of about 0.5 brix to about 2.5 brix. In still other embodiments, the beverage can be formulated as a concentrate designed for the addition of water close in time to the point of consumption. In these embodiments, the amount of water can be lower, so as to result in a beverage concentrate of about 20 brix to about 60 brix.

In still other embodiments, the beverage product is formulated as a beverage powder with little to no water added that can then be reconstituted into a beverage having a solids content of about 0.5 brix to 6.5 brix. It will be appreciated that as used herein, the term “beverage” shall include ready-to-drink beverages, beverage concentrates, and beverage dry mixes or powders, unless the context dictates otherwise. In still other embodiments the product can be a food product. The food product can be substantially solid. It will be appreciated that references herein to components, relative amounts, and ratios can also be applied to food products versus beverages, beverage concentrates, and beverage mixes.

### Other Components

It will be appreciated that beverages (or beverage mix powders, concentrates, or food products) in accordance with embodiments herein can include many other food grade components beyond those discussed above. By way of example, beverages in accordance with embodiments herein can include natural and/or artificial flavoring agents, natural and/or artificial coloring agents, vitamins, minerals, fortifying agents, buffering agents, chelating agents, stabilizers, antioxidants, salts, and the like.

The present invention may be better understood with reference to the following examples. These examples are intended to be representative of specific embodiments of the invention, and are not intended as limiting the scope of the invention.

### EXAMPLES

### Example 1

### Effect of Beverage on Performance During Endurance Exercise

A study was conducted to evaluate the hypothesis that a beverage in accordance with embodiments herein can serve as an effective hydration beverage during endurance exercise performed in a hot environment. This hypothesis was tested using a placebo controlled and double-blind randomized clinical trial. Twelve endurance trained male cyclists completed the protocol. Each subject participated in preliminary testing to define their maximum oxygen uptake and to assign the exercise intensity (60% of VO2max) to be used in the experimental trials.

Three different types of beverages were evaluated for this study (a test beverage and two controls). The test beverage (TA) was formulated as shown in the following table.

| Ingredient | Amount | |
|---|---|---|
| Yellow Sweet Potato Juice | 8.06% | by wt. |
| Concentrate - 60 Brix | | |
| Anhydrous Citric Acid | 0.23% | by wt. |
| Stevia Reb A 95 | 0.02% | by wt. |
| Natural Flavoring | 0.203% | by wt. |
| Anti-Foaming Agent (20% | 0.0045% | by wt. |
| DOW CORNING 1520) | | |

| | |
|---|---|
| Water | Balance (to result in solids of 5.1 Brix) |

The first control beverage (PLA) was formulated as shown in the following table:

| Ingredient | Amount |
|---|---|
| Sucralose | 0.02% by wt. |
| Anhydrous Citric Acid | 0.3% by wt. |
| Natural Flavoring | 0.25% by wt. |
| Artificial Coloring | 0.05% by wt. |
| Water | Balance |

The second control beverage (CW) was a commercially available coconut water (VitaCoco).

Each subject then participated in three 90 minute cycling sessions while consuming either the experimental beverage (TA), or one of the control beverages (PLA) or (CW). Ingestion was allowed ad libitum and both frequency and volume of fluid consumed were recorded. Subjects were kept unaware that their ingestion patterns were being recorded. This was to avoid the Hawthorne effect in which research participants alter their behaviors when they know they are being monitored. The order of treatments was randomized and beverages were coded as A, B, or C. Each endurance ride was conducted in the morning following an overnight fast. Diet was recorded for three days before the first experimental trial and repeated for the subsequent trials. Subjects were told that the purpose of the study was to compare three sport hydration beverages for efficacy in maintaining hydration status during exercise in the heat. All experimental trials were conducted in a thermostatically controlled heat chamber that was kept at 30 C and 50% relative humidity. Beverages were served at subjects' request, kept at refrigerator temperature (4 degrees Celsius) and provided to subjects in opaque sport-drink bottles.

Although the original proposal called for ten subjects, three of the original subjects who were recruited were not able to complete the protocol due to scheduling conflicts. When this occurred, a new subject was recruited to replace the subject who discontinued participation. Also, due to variability in responses among the subjects, it was decided to recruit two additional subjects to increase the statistical power of the study. Therefore, the final subject number was 12.

Significant differences were declared when p<0.05. Generally, the statistical model used was analysis of variance for repeated measures (ANOVA). When variables were measured over time during exercise, a two-way ANOVA was used with beverage as the first factor and time as the second factor. When a p value between 0.05 and 0.15 was obtained in the ANOVA, this was noted as a trend for significance. Results are shown as mean and SD for each beverage or beverage×time. In addition, Cohen's effect size was calculated by comparing the lowest mean to the highest for each variable: Effect size=(Mean1−Mean2)/pooled SD. Interpretation of effect size was according to Cohen: 0.2—Small effect; 0.5—Medium effect; 0.8—Large effect.

### Results

Table 1 (below) shows results of mean body temperature throughout the exercise trial. The results show that the subjects experienced mild to moderate heat stress during all experimental trials as shown by the rise in core temperature. It should be noted that not all subjects completed the full 90 minute exercise in all three trials. A trial was terminated when the subject indicated he could no longer continue due to exhaustion or heat stress. Consequently, the temperature reported for 90 minutes represents the mean of 9 subjects.

TABLE 1
Body core temperature during exercise while consuming
experimental beverages ad libitum. No significant differences were
observed. This is consistent with only small differences in fluid intake -
i.e., ingestion of any water-containing liquid will blunt temperature
rise if enough fluid is consumed.

| | Pre-Ex | 30 min | 60 min | 90 min |
|---|---|---|---|---|
| TA | 36.9 | 37.1 | 38.1 | 38.9 |
| | 0.1 | 0.5 | 0.5 | 0.2 |
| PLA | 37.0 | 38.1 | 38.1 | 38.7 |
| | 0.3 | 0.3 | 0.3 | 0.2 |
| CW | 36.7 | 37.0 | 37.9 | 39.2 |
| | 0.1 | 0.5 | 0.5 | 0.3 |

Body fluid balance during the exercise was assessed as total fluid intake minus fluid output (sweat and urine), which is also equal to body weight change from pre- to post-exercise. There was no correction for either respiratory water loss or metabolic water production because these were likely similar between the beverage trials. For this reason, sweat production is likely over-estimated by a small amount and is not likely to be different among the three beverage trials. The data are shown in Table 2 and the negative net fluid balance at the end of exercise suggests that the subjects experienced voluntary dehydration during all 3 treatments. This is typical of endurance exercise in the heat when drinking is allowed ad lib as drinking to thirst is known to lag behind sweat loss. Thus, palatable beverages are known to encourage increased drinking throughout exercise and reduce the amount of voluntary dehydration. This seems to be the case in the TA treatment compared with CW and to a lesser extent with PLA. Subjects rated (Table 3) the taste and desirability of TA higher than the other two beverages thereby increasing the volume of this beverage consumed and resulting in less negative body fluid balance (compared to CW) at the end of exercise.

When fluid intake was analyzed with ANCOVA, the beverage effect was p=0.06, very close to the p<0.05 significance level. For a quadratic effect of beverage on intake, p=0.04. It therefore seems that the beverage intake differences are reliable with the difference between the extremes (TA vs CW) accounting for this effect.

The ANCOVA testing effect of beverage on net fluid balance at end of exercise revealed p=0.15 for the beverage effect. Forcing the post hoc test, TA vs CW yielded p=0.08. Thus, the difference in net fluid balance between TA and CW approaches significance and is likely a meaningful effect as indicated by the moderate effect size (d=0.48).

Whether the reduced dehydration in the TA trial improves exercise performance cannot be answered in this study because assessing performance capacity was not a focus of this study. It is possible that the relatively small amount of dehydration experienced in this protocol was not sufficient to impair either performance or thermoregulation. Numerous prior studies have supported the finding that performance and thermoregulation are not impaired until dehydration reaches roughly 2% loss of body mass. In the present study, ingestion of TA resulted in dehydration of 1.7%, PLA resulted in 1.9%, and CW resulted in 2.1%. Thus, the trial ended before differential effects on performance or thermoregulation would be expected to occur.

TABLE 2
Mean ± SEM body water dynamics during endurance exercise while
consuming the 3 test beverage. Fluid intake is cumulative ad lib intake
during exercise, sweat loss is calculated from body mass change plus
fluid intake from beginning to end of exercise, urine loss taken from
urine volume collected after end of exercise, and net fluid balance
calculated as body mass change from beginning to end of exercise.
All volumes are expressed as mL. Significance tested with repeated
measures ANCOVA with body wt. as covariate. Effect size (Cohen's d)
calculated only for differences between highest and lowest means.

| | | | | ANCOVA | Effect |
|---|---|---|---|---|---|
| Query | TA | PLA | CW | p | Size |
| Fluid Intake | 888 | 828 | 812 | 0.06 | 0.21 |
| | 91 | 123 | 114 | | |
| Sweat Loss | 2202 | 2277 | 2387 | 0.28 | 0.32 |
| | 171 | 144 | 165 | | |
| Urine Loss | 143 | 116 | 129 | 0.33 | 0.13 |
| | 34 | 29 | 34 | | |
| Net Fluid Bal. | −1314 | −1449 | −1575 | 0.15 | 0.48 |
| | 145 | 176 | 171 | | |

TABLE 3
Results (mean ± SEM) from the post-exercise visual-analog scale of
subject assessments of beverage qualities. Subjects were asked to
indicate their response along a 9 cm line. Distance (cm) from start of
line used as measure of their response. Low and high anchor terms
are indicated for some questions.

| | | | | | Effect |
|---|---|---|---|---|---|
| Query | TA | PLA | CW | p | Size |
| How thirsty are you now? | 5.8 | 5.5 | 7.1* | 0.04 | 0.77 |
| | 0.6 | 0.7 | 0.6 | | |
| Stomach full (“none” to “very full”) | 4.5 | 5.0 | 3.8 | 0.52 | 0.43 |
| | 0.8 | 0.7 | 0.7 | | |
| Abdom. discomfort (gas pains, etc) | 2.3 | 3.2 | 3.5 | 0.26 | 0.39 |
| | 0.8 | 1.0 | 0.9 | | |
| Overall taste of beverage | 7.3 | 6.8 | 3.8* | 0.002 | 1.69 |
| | 0.5 | 0.6 | 0.8 | | |
| Flav. rating (“don't like it” to | 7.0 | 6.6 | 3.2* | 0.003 | 1.57 |
| “like a lot”) | 0.6 | 0.7 | 0.8 | | |
| How refreshing is the beverage | 6.6 | 5.3 | 4.4* | 0.03 | 0.91 |
| | 0.8 | 0.7 | 0.7 | | |
| How well did it quench thirst | 6.5 | 5.2 | 4.9 | 0.09 | 0.58 |
| | 0.8 | 0.8 | 0.7 | | |
| How much after-taste (“none” to | 4.5 | 6.1 | 4.9 | 0.19 | 0.66 |
| “extreme”) | 0.7 | 0.6 | 0.7 | | |
| Do you like it (“dislike” to “like”) | 6.4 | 5.0 | 4.1* | 0.02 | 0.95 |
| | 0.6 | 0.7 | 0.8 | | |
| Overall satisfaction with beverage | 6.1 | 5.2 | 4.2 | 0.06 | 0.78 |
| | 0.6 | 0.8 | 0.7 | | |
| Consistency (“too thin” to “too thick”) | 4.8 | 5.7 | 5.7 | 0.10 | 0.87 |
| | 0.1 | 0.4 | 0.3 | | |
| Aroma (“too weak” to “too strong”) | 4.9 | 5.3 | 5.3 | 0.67 | 0.28 |
| | 0.3 | 0.4 | 0.2 | | |
| Sweet (“not enough” to “too sweet”) | 5.5 | 6.3 | 3.4* | 0.002 | 1.14 |
| | 0.4 | 0.6 | 0.6 | | |

TABLE 4
Results of question 14. Subjects were asked to check all that apply.
Scores are the number of subjects (out of 10) who checked that item. E.g.,
for “It's a flavor I like” 9 subjects checked this in the TA trial,
7 checked this in PLA, and 2 checked this in CW.

| | | | Coconut |
|---|---|---|---|
| Query | TA | Placebo | Water |
| It's a flavor I like | 10 | 9 | 2 |
| Has a delicious taste | 8 | 5 | 1 |
| It's for someone like me | 2 | 2 | 2 |
| Good for my fitness routine | 2 | 2 | 2 |
| Helps me restore my energy | 7 | 3 | 4 |
| Enjoyable to drink | 7 | 6 | 2 |
| It's refreshing | 6 | 5 | 1 |
| Helps to quench my thirst | 7 | 5 | 6 |

### Analysis:

It is clear from the data in Tables 3 and 4 from the questionnaires that subjects preferred the TA beverage over CW and PLA. This is evident in the post-exercise visual-analog questionnaire on which subjects rated TA highest of the beverages in overall taste, flavor, refreshing, how much they liked the beverage, and their satisfaction with the beverage. Their preference for TA was also indicated in the question 14 check marks in which 10 of 12 chose “a flavor I like”, and 8 of 12 chose “delicious taste”.

As expected, their preference for TA also corresponded with increased drinking volume of this beverage throughout the exercise. Increased drinking volume consequently reduced the magnitude of negative fluid balance incurred during the exercise. This may therefore offer a protective effect against developing excessive dehydration (>2% loss of body mass) and its negative effects on both performance and thermoregulation.

### Further Data Tables

TABLE 5
Results (mean ± SEM) of plasma concentration of potassium
(mEq/L). 90 minute value represents the end exercise value as not
all subjects completed the full 90 minutes. Significant effect of
time, no effect of beverage. None of the beverages are particularly
high in potassium and the small rise during exercise is commonly
observed due to elevated K+ in extracellular fluid of muscle leaking
into circulation.

| | Pre-Ex | 30 min | 60 min | 90 min |
|---|---|---|---|---|
| TA | 4.4 | 5.2 | 5.3 | 5.3 |
| | 0.1 | 0.1 | 0.1 | 0.1 |
| PLA | 4.3 | 5.1 | 5.1 | 5.1 |
| | 0.1 | 0.1 | 0.1 | 0.1 |
| CW | 4.5 | 5.3 | 5.3 | 5.5 |
| | 0.1 | 0.1 | 0.2 | 0.2 |

TABLE 6
Results (mean ± SEM) of plasma concentration of sodium (mEq/L).
90 minute value represents the end exercise value as not all subjects
completed the full 90 minutes. There was a significant effect of time,
but since none of the beverages were high in sodium it was expected that
there would be little effect of beverage on plasma sodium. Effect of
exercise time expected as result of movement of plasma water into
muscle combined with plasma water loss from sweating.

| | Pre-Ex | 30 min | 60 min | 90 min |
|---|---|---|---|---|
| TA | 136 | 138 | 138 | 138 |
| | 0 | 0 | 0 | 1 |
| PLA | 136 | 138 | 138 | 139 |
| | 0 | 0 | 1 | 1 |
| CW | 136 | 139 | 139 | 139 |
| | 0 | 1 | 1 | 0 |

TABLE 7
Results (mean ± SEM) of heart rate response (beats/min). 90 minute
value represents the end exercise value as not all subjects completed the
full 90 minutes. Used as indirect indicator of heat stress as long as
exercise intensity is controlled. In all treatments, subjects experienced
some heat stress but not affected by the beverage. Supplements
findings from core temperature.

| | 30 min | 60 min | 90 min |
|---|---|---|---|
| TA | 154 | 167 | 169 |
| | 4 | 4 | 5 |
| PLA | 153 | 165 | 171 |
| | 3 | 4 | 4 |
| CW | 152 | 163 | 168 |
| | 3 | 3 | 3 |

TABLE 8
Results (mean ± SEM) of oxygen uptake (ml/kg/min). 90 minute
value represents the end exercise value as not all subjects completed the
full 90 minutes. Slight rise with exercise time likely due to heat stress and
loss of plasma water. Lack of difference between beverages confirms
exercise intensity was same among the trials.

| | 30 min | 60 min | 90 min |
|---|---|---|---|
| TA | 35.9 | 36.4 | 36.7 |
| | 1.0 | 1.0 | 0.9 |
| PLA | 35.0 | 36.0 | 36.6 |
| | 0.9 | 0.9 | 0.9 |
| CW | 34.9 | 35.4 | 36.2 |
| | 0.7 | 0.7 | 0.8 |

TABLE 9
Ratings of perceived exertion (mean ± SEM). 90 minute value represents
the end exercise value as not all subjects completed the full 90 minutes.
Because of developing heat stress, we expect RPE to rise much like
heart rate indicating subjects getting less comfortable with the exercise
over time. Even though subjects had reliable preferences of some
beverages over others, this did not influence their perception of effort on
the exercise.

| | 30 min | 60 min | 90 min |
|---|---|---|---|
| TA | 13 | 15 | 16 |
| | <1 | <1 | <1 |
| PLA | 13 | 15 | 16 |
| | <1 | <1 | <1 |
| CW | 13 | 15 | 16 |
| | <1 | <1 | <1 |

TABLE 10
Urine concentration of potassium (mEq/L) (mean ± SEM). Significant
effect of time, trend for higher potassium in CW (p = 0.11). We expected
a rise in urine K+ in consequence to rise in plasma K+ (potassium
spill-over into urine.

| | Pre-exerc | Post-exerc |
|---|---|---|
| TA | 20.2 | 32.4 |
| | 2.7 | 3.5 |
| PLA | 27.9 | 34.4 |
| | 5.1 | 4.2 |
| Coconut Water | 34.7 | 41.8 |
| | 5.1 | 3.2 |

TABLE 11
Urine concentration of sodium (mEq/L) (mean ± SEM). Urine sodium
usually falls in response to kidney going into fluid conservation mode
(aldosterone secretion promotes sodium and water reabsorption in distal
renal tubules) during exercise in the heat.

| | Pre-exerc | Post-exerc |
|---|---|---|
| TA | 54 | 37 |
| | 11 | 5 |
| PLA | 68 | 43 |
| | 12 | 8 |
| Coconut Water | 76 | 47 |
| | 15 | 10 |

This example shows that beverages in accordance with embodiments herein can improve hydration as subjects consuming such beverages consumed more fluids compared to water or coconut water and tended to maintain better overall hydration status. This example also shows that beverages in accordance with embodiments herein encourage fluid intake. This example further shows that beverages in accordance with embodiments herein can be used to help maintain body temperature during exercise. Finally, this example shows that beverages in accordance with embodiments herein can help maintain electrolyte balance.

### Example 2

### Effect of Beverage on Performance During Endurance Exercise

### Participants:

This study included trained long-distance runners, cyclists or triathletes. Inclusion criteria included male and females between the ages of 19 and 50 years; a minimum of two years of involvement in endurance sports; and a minimum of six training-hours per week. Exclusion criteria included cardiovascular disease, metabolic disease, relevant food allergies, and individuals that smoked.

### Procedures:

On the first visit to the laboratory, participants were asked to fill out a medical history questionnaire. Further, height and weight was measured and body mass index (BMI) was calculated.

Each participant completed an initial maximal incremental exercise test on the cycle ergometer to determine VO₂ₘₐₓ and therefore power at maximum VO2 (Pₘₐₓ). Following that, participants participated in three submaximal experimental trials. Participants were advised to refrain from strenuous activity in the 48 hours preceding the maximal exercise test and all three trials to avoid residual fatigue or delayed onset muscle soreness. They were also advised to fast the night prior to reporting the laboratory for exercise testing, but to hydrate appropriately and be well rested. All exercise trials were completed the same time of day to maximize consistency between trials.

### Exercise Test:

Blood pressure, heart rate (Polar Electro) and rating of perceived exertion (RPE) were measured at rest and during the last minute of every stage in the protocol. Following the cessation of the test, blood pressure and heart rate were measured every minute during a 5-minute recovery. Following a three-minute warm up on the cycle ergometer participants cycled at a chosen cadence between 85-100 r·min⁻¹ at 100 W. Power output was increased by 50 W every two minutes until participants reached volitional exhaustion as determined by the inability to maintain chosen pedal cadence. Participants were asked to pedal at the same cadence in the subsequent experimental trials. Expired gases were measured utilizing a metabolic system (ParvoMedics, Sandy, Utah.) and maximal oxygen uptake was calculated by using the mean maximal 60-second output. Similarly, Pₘₐₓ was defined as the power output at the final stage of the test. The test was discontinued if any of the following criteria were met: participant requests that the test be stopped for any reason, participant reaches volitional exhaustion, participant displays any signs or symptoms that indicate the test should be stopped, participant can no longer maintain the required workload, or the tester feels for any reason it is unsafe to continue (ACSM, 2009).

### Experimental Trials:

Participants completed a total of three experimental trials, each separated by at least one week. Three conditions were randomly assigned to each participant's beverage consumption during the recovery period—sweet potato juice (SPJ), commercial sports drink (CD), or very low-calorie flavored water (FW). For the three experimental trials, participants were asked to follow a standardized diet for the 48 hours previous to each trial. Participants were permitted to drink water ad libitum during all experimental trials, and water consumption was recorded.

### Glycogen Depletion Trial:

Participants cycled at alternating 2 minutes of 90% of Pₘₐₓ and 2 minutes of 50% Pₘₐₓ, as a recovery. Participants began the trial cycling at 90% Pₘₐₓ and intensity was decreased by 10% when participants could no longer maintain the chosen cadence. The trial ended when participants could not maintain their previously chosen cadence while cycling at 60% Pₘₐₓ. RPE and heart rate were measured every ten minutes. Both prior to and immediately following the glycogen depletion trial and the endurance trial, blood lactate and blood glucose was measured. Lactate (Lactate Plus, Biomed) and blood glucose (AccuCheck, Roche Diagnostics, USA) were measured by performing a finger stick and drawing approximately 5 to 25 microliters of blood onto a strip for immediate analysis. Additionally, total body water (TBW) was measured immediately prior to and after the glycogen depletion trial using bioelectrical impedence (Tanita BC-418, Tanita, Arlington Heights, Ill.).

### Recovery Period:

Following the glycogen depletion trial participants rested in the lab for a 4-hour recovery period. Immediately and 2 hours post-exercise, participants consumed the randomly assigned beverage that provided 1.0 g CHO·kg of body mass (BM) or the placebo. Blood lactate, blood glucose, and TBW were measured at 2-hours into the recovery period, just prior to ingesting the second beverage. During recovery, participants also rated their mood, appetite, and GI distress using a 100 mm visual analog scale immediately after the first and second beverage, and just before the endurance trial. The mood and appetite scale included the question “How [word] are you?” with the word clear-headed, energetic, tired, sore, full, bloated, and hungry inserted. The scale was anchored by “not at all” at the left end and “very much so” at the right end. The participants were asked to draw a line through the continuum to indicate his or her position on the scale. Participants also completed a questionnaire that focused on taste acceptability, aftertaste, and reason for consuming the beverage. Participants were allowed to drink water ad libitum during the recovery period, but no other food or beverage was permitted.

### Endurance Capacity Trial:

Post recovery, participants completed a cycle to exhaustion (70% Pmax). Pedal cadence was monitored and the trial was terminated when the cadence dropped by more than 10 r·min⁻¹ for greater than 20 seconds on two occasions. Both prior to and following the experimental trials blood lactate, blood glucose, total body water were measured. Also, RPE, HR, and GI distress was measured every ten minutes. GI distress was measured using a 100 mm visual analog scale which was anchored by “no discomfort at all” at the left end and “very severe discomfort” at the right end. At the completion of the trial, the questionnaire same as the one completed at 2-hour recovery was completed again.

### Conditions

A test beverage (SPJ), a commercial sports drink (CD) (Orange Gatorade), and flavored water (FW) were randomly assigned to each participant for each of the three trials. The SPJ and CD were matched for total carbohydrate content and osmolality. The SPJ beverage was prepared as shown in the following table:

| Ingredient | Amount |
|---|---|
| Yellow Sweet Potato Juice Concentrate - | 8.06% by wt. |
| 60 Brix | |
| Anhydrous Citric Acid | 0.23% by wt. |
| Stevia Reb A 95 | 0.02% by wt. |
| Natural Flavoring | 0.203% by wt. |
| Anti-Foaming Agent (20% DOW | 0.0045% by wt. |
| CORNING 1520) | |
| Water | Balance (to 5.1 Brix) |

The FW beverage (same as above) was formulated as shown in the following table:

| Ingredient | Amount |
|---|---|
| Sucralose | 0.02% by wt. |
| Anhydrous Citric Acid | 0.3% by wt. |
| Natural Flavoring | 0.25% by wt. |
| Artificial Coloring | 0.05% by wt. |
| Water | Balance |

Beverages were premixed and poured into identical-looking aluminum sports bottles coded for the beverage they contain.

The SPJ was derived from a sweet potato juice base. An 8-ounce serving contained 43 calories, 10.33 g of glucose-sucrose-fructose in the following ratio (13.5:1.0:1.5), 69 mg sodium and 137 mg potassium.

The CD was an off-the-shelf product. Lab analysis indicated that 8 ounces contained 60 calories, 15 g of glucose-sucrose-fructose (1.4:4.4:1.0), 104 mg sodium and 31 mg potassium.

Eight ounces of the FW contained four calories, 21 mg sodium and 9 mg potassium; and was flavor-matched to the SPJ.

### Diet:

Prior to exercise testing, participants kept a three-day food log. The dietary records were analyzed for energy, carbohydrate, protein, and fat composition using a publically available online dietary assessment program (U.S. Department of Agriculture. ChooseMyPlate.gov Website. Washington, D.C. Food Tracker. www.supertracker.usda.gov/foodtracker.aspx). Using the foods the participants listed on their food logs, a standardized diet was established for them to follow 48 hours prior to any testing. Participants were asked to discontinue all dietary supplement use at least 72 hours prior to any testing.

### Data Analysis:

A sample size calculation was performed for a crossover design (http://hedwig.mgh.harvard.edu/sample_size/js/js_crossover_quant.html using a mean and SD from Thomas et al. To detect a treatment difference (nine minutes), a total of 29 participants were needed for power set at 0.80 percent and an alpha level of 0.05. This was based on the assumption that the within-patient standard deviation of the response variable was 11.

All statistical analyses were performed using GraphPad Prism 5.0 (GraphPad Software, La Jolla, Calif.). All data were checked for normality and sphericity, and Greenhouse-Geisser correction was applied if sphericity was violated. Baseline characteristics were compared using independent samples t-tests and reported as mean±SEM. Data from the three trials was compared using a one-way repeated-measures analysis of variance (ANOVA). Dunnett's test was employed when significance was found. Statistical significance was set at P≦0.05.

### Results:

Twenty-eight participants completed all three trials. Data from two participants was not included in the final analyses because during a trial one participant was given the wrong amount of beverage and one participant was tested at the incorrect workload. Table 2 presents the demographic data of participants. There was a significant difference between males and females for BMI, relative VO2max and absolute VO2max.

Analysis revealed an interaction effect between endurance trial time and the type of beverage consumed (F=6.05, p=0.046). Endurance trial time to fatigue for SPJ, CD, and FW was 26.7 (SD=14.69), 26.3 (SD=15.14), and 21.5 (SD=11.96) minutes, respectively. Dunnett's test determined SPJ and FW were significantly different.

Descriptive statistics for variable of interest are presented in Table 3. There was no significant difference in pre- or post-glycogen depletion lactate or blood glucose levels. Mean post-endurance trial blood lactate levels were significantly lower for FW than both SPJ and CD (F=6.58, p=0.003). Female mean post-endurance trial blood lactate levels was significantly lower for FW than SPJ (F=6.09, p=0.007), and significantly lower for FW than CD for male participants (F=4.35, p=0.020). Mean post-endurance blood glucose level was significantly lower for SPJ than FW (F=5.42, p=0.007), but not CD. Female mean post-endurance blood glucose level was significantly lower for SPJ than FW (F 4.31, p=0.026), and significantly lower for FW than CD for male participants (F=4.13, p=0.026). There were no significant differences for mean endurance trial 10-minute HR or RPE for the three beverages. There were no differences for TBW between or within the trials. There were no significant differences between mean pre-glycogen depletion, post-glycogen depletion, or 2-hour recovery lactate or BG for the three beverages.

The combined mean score for all three mood and appetite VAS scales completed during each trial are presented in Table 4. There were no significant differences between the VAS scale scores for all three beverages.

### Discussion:

The aim of this study was to assess the effect of three beverages consumed during recovery from glycogen-depleting exercise on subsequent endurance capacity in cycling. Participants cycled for 24.2% and 22.3% longer after ingesting SPJ and CD, respectively, than when they consumed FW.

The SPJ contained less sodium than the CD. We found that the lower amount of sodium in the SPJ did not result in decreased performance during the endurance trial. One explanation may be that the participants maintained their hydration status throughout the trial per total body water measures. Although one study found moderate levels of sodium to be more effective than sodium-free drink at rehydration during recovery, time to exhaustion in the exercise capacity test was not different between treatments (P=0.883). The lab setting and length of the exercise bouts may not have resulted in a need for electrolyte replacement, as a reduction of 1-2% body mass does not appear to inhibit aerobic performance, especially with exercise less than 90 minutes and a temperate environment. Lastly, the need to replace sweat-related sodium losses during exercise generally applies to exercise lasting greater than two hours, unless the athlete is exercising in a hot and humid environment.

Mean blood lactate levels immediately post-endurance capacity trial were significantly lower for flavored water than SPJ. Mean blood glucose levels immediately post-endurance capacity trial were significantly lower for SPJ than FW.

Our study found gender differences in some measures. Female post-endurance blood lactate was significantly higher for SPJ than FW, whereas male lactate levels were significantly higher for CD than FW. Female blood glucose was significantly lower for SPJ than FW, although this was not found with male participants.

### Conclusion:

The data from this example show that beverages in accordance with embodiments herein can improve endurance capacity. In particular, this study shows that ingesting two doses at 1.0 g CHO·kg⁻¹ BM of a beverage in accordance with embodiments herein during recovery from glycogen-depleting exercise resulted in significantly longer time to exhaustion than consuming flavored water. The results of this study support the recovery effects of beverages in accordance with embodiments herein. The data further suggest that beverages in accordance with embodiments herein can enhance utilization of glucose.

### Example 3

### Low Brix Formulations

A low brix formulation was prepared by mixing the following components.

| Ingredient | Amount |
|---|---|
| Yellow Sweet Potato Juice Concentrate - | 2.00% by wt. |
| 60 Brix | |
| Cucumber Juice Concentrate - 45 Brix | 0.86% by wt. |
| Other Juice Concentrates | 0.30% by wt. |
| Natural Flavoring | 0.217% by wt. |
| Anti-Foaming Agent (20% DOW | 0.0045% by wt. |
| CORNING 1520) | |
| Water | Balance (to 1.8 Brix) |

The formulation had approximately 20 calories per 12 ounce serving. The formulation was calculated to have a glucose+sucrose:fructose ratio of about 5:1.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A beverage comprising:
a fruit or vegetable juice, wherein the fruit or vegetable juice provides at least 50% of the carbohydrates of the beverage; and
water;
wherein the ratio of glucose+sucrose:fructose in the beverage exceeds a ratio of 2:1.

2. The beverage of claim 1, wherein the fruit or vegetable juice provides at least 70% of the carbohydrates of the beverage.

3. The beverage of claim 1, wherein the fruit or vegetable juice provides at least 90% of the carbohydrates of the beverage.

4. The beverage of claim 1, further comprising a sweetness enhancer.

5-8. (canceled)

9. The beverage of claim 7, the acidulant selected from the group consisting of citric acid, malic acid, and salts thereof.

10. The beverage of claim 1, the beverage comprising a pH of about 2.5 to about 4.5.

11. The beverage of claim 1, wherein the beverage is shelf-stable.

12. The beverage of claim 1, wherein the fruit or vegetable juice is selected from the group consisting of one or more of sweet potato, carrot, peach, and orange juices.

13. The beverage of claim 1, wherein the fruit or vegetable juice is made from a white or yellow flesh sweet potato.

14. (canceled)

15. The beverage of claim 1, wherein the fruit or vegetable juice has a glucose+sucrose:fructose ratio of 3:1 or more.

16. The beverage of claim 1, wherein the fruit or vegetable juice has a glucose+sucrose:fructose ratio of 4:1 or more.

17. The beverage of claim 1, wherein the fruit or vegetable juice is a clarified juice product.

18. The beverage of claim 1, wherein the ratio of glucose+sucrose:fructose in the beverage exceeds a ratio of 3:1.

19. The beverage of claim 1, wherein the ratio of glucose+sucrose:fructose in the beverage exceeds a ratio of 4:1.

20. The beverage of claim 1 comprising a calorie content of less than about 120 for a 12 ounce serving.

21. (canceled)

22. The beverage of claim 1 comprising a calorie content of less than about 20 for a 12 ounce serving.

23-24. (canceled)

25. The beverage of claim 1, comprising about 15-150 mg of sodium and about 15-150 mg of potassium.

26. The beverage of claim 1, wherein the beverage is substantially isotonic.

27-28. (canceled)

29. A method of enhancing athletic endurance comprising:
administering a beverage to a subject, the beverage comprising a fruit or vegetable juice, wherein the fruit or vegetable juice provides at least 50% of the carbohydrates of the beverage; and
water;
wherein the ratio of glucose+sucrose:fructose in the beverage exceeds a ratio of 2:1.

30. (canceled)

31. A beverage comprising:
a fruit juice, vegetable juice, tree sap or syrup, molasses, nut milk, or grain milk component wherein the fruit juice, vegetable juice, tree sap or syrup, molasses, nut milk, or grain milk component provides at least 50% of the carbohydrates of the beverage; and
water;
wherein the ratio of glucose+sucrose:fructose in the beverage exceeds a ratio of 2:1.
